(19) United States
(12) Patent Application Publication
(10) Pub. No.: US 2009/0077565 A1
(43) Pub. Date: Mar. 19, 2009

(54) SYSTEM AND METHOD FOR ENHANCING INTERACTIVE WEB-BROWSING EXPERIENCE

(76) Inventor: Joseph Frazier, McCammon, ID (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/193,699

(22) Filed: Aug. 18, 2008

Related U.S. Application Data
(60) Provisional application No. 60/965,336, filed on Aug. 17, 2007.

(51) Int. Cl. G06F 9/54

(52) U.S. Cl. 719/311

(57) ABSTRACT

The system and method provides enhanced interactive web-browsing through multiple websites and supporting multiple application formats. An application presents the end-user with the ability to quickly (e.g., by a one-click operation) jump to a desired website no matter which and how many websites are concurrently activated. In addition to enhancing the end-users web-browsing experience, the application provides a platform with the ability to dynamically and contextually present suggestions and advertisements to the end-user.

### RELATED APPLICATION

This claims priority under 35 U.S.C. § 119 from U.S. provisional patent application Ser. No. 60/965,336, filed Aug. 17, 2007 entitled “System and Method for Enhancing Interactive Web-Browsing Experience,” which application is incorporated by reference here for its full disclosure.

### BACKGROUND

With the rapid increase in the number and variety of websites and their application formats, the efficiency of browsing multiple websites has decreased proportionately. Conventional web-browsing systems did not fulfill the full potential of the web browser's ability to provide useful suggestions and advertisements to end-users. The present invention aims to solve the above inadequacies by providing a system and method for enhancing the interactive web-browsing experience.

### SUMMARY

One aspect of the present invention provides a method for exchanging data with a server including providing a launch script stored on a local server. The method includes providing on an end user computer an executable application capable of obtaining the launch script from the server. The method injects and executes the launch script on each of a plurality of web browsers running on the end-user computer such that the executable application can access a rich-media function through which an operator of the end-user computer can obtain data and perform on-line activities. The operator's on-line activities are communicated to the remote server. The executable application provides a plurality of suggestions to the operator based on the operator's on-line activities.

Another aspect of the present invention provides a data exchange communication system comprising a server having a memory that stores a launch script and an end-user computer connected to the server via a network. The end-user computer comprises an executable application capable of obtaining the launch script from the server and injecting and executing the launch script on each of a plurality of web-browsers running on the end-user computer such that the executable application renders a rich-media through which the operator of the end-user computer can obtain data and perform on-line activities. The executable application communicates the operator's on-line activities to the server and provides a plurality of suggestions to the operator based on the operator's on-line activities.

### BRIEF DESCRIPTION OF THE DRAWING

FIG. 1 is a flow chart of one embodiment of a web-browser extension according to the present invention.

FIG. 2 is a flow chart of one embodiment of a data exchange communication system according to the present invention.

FIG. 3 is a flow chart of one embodiment of a method for bypassing a local firewall according to the present invention.

It should be noted that the Figures are only intended to facilitate the description of the preferred embodiments of the present invention. The figures do not illustrate every aspect of the present invention and do not limit the scope of the invention.

### DETAILED DESCRIPTION OF THE PREFERRED EMBODIMENTS

Aspects of the present invention provide systems and methods that enhance the end-user's web-browsing experience. In one embodiment of the present invention, an application that enhances the end-users' web-browsing experience includes a rich-media function, for example a built-in information feeder in an RSS format, directly into the web-browser's web-pages. The rich-media function may be composed of HTML, CSS, graphics, JavaScript, flash and any other technology that is interpretable via a web browser. Generally, rich media is a technology that provides interactivity or multi-media to a user through the web. Such an application presents the end-user with the ability to quickly (e.g., by a one-click operation) jump to a desired website no matter which and how many websites are concurrently activated. In addition to enhancing the end-user's web-browsing experience, implementations of aspects of the present invention may provide a platform with the ability to dynamically and contextually present suggestions and advertisements to the end-user.

Boomerang Architecture:

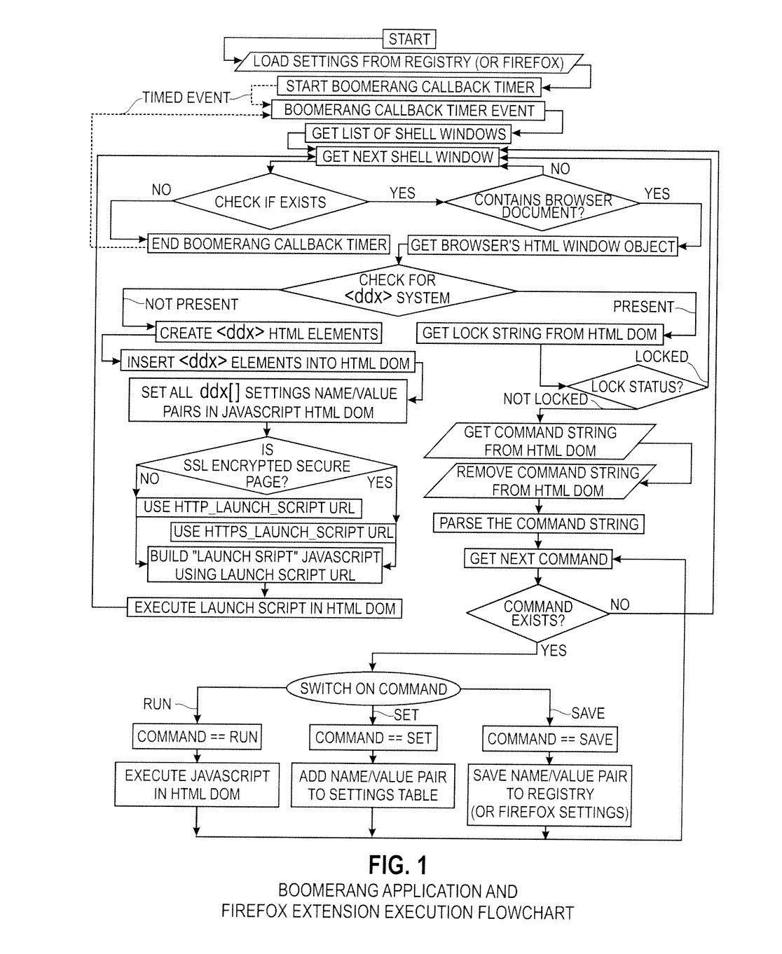

The “Boomerang” is a stand-alone executable application or web-browser extension which establishes a “data exchange communication system” between web-browsers and Boomerang servers. It is designed to inject into and initiate execution of JavaScript code in web-browsers. The JavaScript code that is injected into the web-browser is referred to as the “Boomerang launch script.” Upon execution of the Boomerang launch script, the launch script then determines what is to be displayed to the end-user. The launch script can use the Boomerang “data exchange communication system” to retrieve, set and save settings, execute more JavaScript code, and open windows and message boxes. FIG. 1 shows a framework for execution of commands, functions and scripts within the Boomerang executable application or web-browser extension.

Preferably, the Boomerang executable application causes the browser to display the appearance or “skin” of the Boomerang environment and, through the execution of a rich-media function, to provide the end user with a set of enhanced browsing functions. The instantiation of the Boomerang environment may, for example, be a bar or region within a browser to indicate where an end-user can access the Boomerang functionality. The set of enhanced browsing functions may include one or more sets of dynamic cascading menus, which are context sensitive and provide context derived navigation suggestions. For example, a bar implementation of the Boomerang functionality may provide a number of different menus such as “news”, “sports” and “search” that appear only when activated, for example, by having a mouse pointer dragged over the bar or area from which the cascading menu appears. The Boomerang environment may also provide a news feed or directed advertisement, or both as desired, with the advertisement preferably selected based on context such as a URL history and the news feed customized to the end-user's selections or history.

In a further enhancement to the browser functionality, the Boomerang application may detect when an end-user performs a search and detect the subject matter of the search. Based on the subject matter of the search, the remote server may provide directed advertisement or other web content based on the contents or context of the search subject matter. This would be a supplement to the search functionality and preferably would be displayed within the browser alongside the results of the conventional search engine. For example, the supplemental search results might be displayed in a region along the right or left hand edge of the browser.

Boomerang Launch Script:

In one embodiment of the present invention, hard coded into the Boomerang are two URLs to “Boomerang launch scripts.” The “Boomerang launch scripts” are injected into a web browser to instantiate the Boomerang “data exchange communication system.” The first launch script is referred to as HTTP_LAUNCH_SCRIPT and is executed inside a web-browser when the web-browser is visiting a non-secure or unencrypted web-page. The second launch script is referred to as HTTPS_LAUNCH_SCRIPT and is used when the web-browser is visiting a web-page that is encrypted using the HTTPS Secure Socket Layer protocol for communication. The Boomerang launch scripts can be stored on a remote server and can be accessed via their URLs. Because the launch scripts are on a remote server, modifications to the “Boomerang launch script” can be made at anytime by the software developers of the Boomerang who have access to the launch scripts. Modifications to the launch scripts immediately affect all end users upon the next page-load or when their web-browser requests a new copy of the launch script (which is on every page load unless the particular web-browser has temporarily cached the launch script for efficiency).

Boomerang Launch Script Architecture:

In one embodiment of the present invention, the Boomerang launch script is written in JavaScript and is organized into two main sections. The first section is a library of utilities that are used by the Boomerang to perform various tasks. The launch script utilities section is extensible because it is located on a remote server and is sourced remotely via the Boomerang data exchange communication system upon instantiation. Therefore this section of the application can be modified based upon the needs of the users of the application and without the necessity of an additional download of the Boomerang application by the end-user.

The second section instantiates the Boomerang's initial manifestation to the end-user based upon the current “language” and “skin” combination retrieved from the end-user's settings. The second section is also responsible for reporting activity back to the server and introducing any necessary event hooks into the web-browser. The second section may be easily modified by the Boomerang software developers and is extensible in the same fashion as the first section of the Boomerang launch script.

Boomerang Launch Script Variables:

var boomerang_ddx={ }
An associative array of name/value pairs (also commonly referred to as a hash table or a dictionary). This variable holds the settings that are stored in the separate Boomerang application, and is the primary means for the Boomerang application to communicate to the HTTP(S)_LAUNCH_SCRIPT.
boomerang_ddx[‘lang’]=‘en’; or boomerang_ddx.lang specifies the current language to be used.
boomerang_ddx[‘skin’]=‘metal’; or boomerang_ddx.skin specifies the current skin to be loaded by the Boomerang.

var minimum_boomerang_version=20060822;
Contains the minimum version for which this current Boomerang HTTP(S)_LAUNCH_SCRIPT is designed. If the Boomerang application reports an older version than the one provided there then the Boomerang automatically goes into a mode where it displays to the end user a prompt and easy instructions to download the most current version of the Boomerang application.

var boomerang_root_http=“http://www.example.com/boomerang/”;
The root URL for the Boomerang to use when referencing files on the Boomerang server, and is intended for primarily HTTP transactions.

var boomerang_root_https=“https://www.example.com/boomerang/”;
The root URL for the Boomerang to use when referencing files on the Boomerang server, and is intended primarily for HTTPS “secure” transactions.

var boomerang_ssl_on=(document.location.href.indexOf(“https://”)==0 ? true:false);
Holds the Boolean value “true or false” which indicates if the current web transaction is using the HTTPS SSL secure encrypted transmission method.

var boomerang_root_url=(boomerang_ssl_on ? boomerang_root_https:bommerang_root_http);
The root URL to be used during the current transaction. This switches between the boomerang_root_https value and the boomerang_root_http value automatically depending on the current web transmission type (HTTPS or HTTP).

var boomerang_search_suggest_css=boomerang_root_url+“search_suggest.css”; //changethis . . . in search_suggest.php
A URL to the cascading style sheet to be loaded when the “Boomerang search suggest” is activated.

var boomerang_skin=″;
Contains the current “skin” to be loaded by the Boomerang.

var boomermenu_system=null;
A JavaScript function object which contains the reference to the Boomerang's dynamic cascading menu system.

var boomerang_draw_height=0;
Contains the height in pixels of the current Boomerang skin that will be rendered by the web-browser.

var domain_level_{—}3 (boomerang_ddx[‘affiliate_username’]==″∥typeof(boomerrang_ddx.affiliate_username)==‘undefined’ ? ‘www’:boomerang_ddx[‘affiliate_username’]);
Contains the username of the affiliate who is responsible for soliciting the download of the current installation of the Boomerang application on any particular end user's computer.

var boomerang_browser=(navigator.appName==‘Microsoft Internet Explorer’ ? ‘ie’:‘netscape’);
Specifies which web-browser is in use. The Boomerang currently supports the following web-browsers: Internet Explorer 6 and 7 for Windows and Firefox 1.2 or greater on both the Windows and Macintosh (OS X) platforms.

var boomerang_platform=(navigator.platform.indexOf(“Mac”)>=0 ? “Mac”: (navigator.platform.indexOF(“Win”)>=0 ? “Win”: navigator.platform));
Specifies the current computer platform in use by the end user. The Boomerang currently supports the following computer platforms: Microsoft Window (98, Me. NT, XP, etc.) and Macintosh OS X.

var boomerang_debug_mode=false;
A Boolean value used to determine if the Boomerang HTTP(S)_LAUNCH_SCRIPT should be executing code that is not meant to be ran when being used by the general public. This is a value that can be set to “true” if the current GUID is one which identifies the Boomerang of an application developer of the Boomerang software system. This is a useful feature to be used when developing additional functionality into the HTTP(S)_LAUNCH_SCRIPT, because it allows sections of the Boomerang code to be worked on without the worry of interfering with the end-user's browsing experience.

var boomer_searchsuggest_triggers = Array(
‘http://www.google.com/search?’, ‘http://www.google.es/search?’
, ‘http://search.yahoo.com/search?’, ‘http://es.search.yahoo.com/search?’
, ‘http://search.msn.com/results.aspx?’
, ‘http://search.live.com/results.aspx?’
, ‘http://www.ask.com/web?’, ‘http://es.ask.com/web?’
, ‘http://www.altavista.com/web/results?’,
‘http://es.altavista.com/web/results?’
, ‘http://search.lycos.com/?’, ‘http://buscador.lycos.es/?’
, ‘http://www.alltheweb.com/search?’
, ‘http://www.hotbot.com/index.php?’
);

An array that contains a list of URLs which when visited causes the Boomerang to activate the Boomerang search suggest system.

Boomerang Launch Script Utilities Detail:

function boomerang_ddx_lock(lock_bool)
this locks and unlocks the Boomerang ddx system which is a “packet drop” system that is used to communicate back to the Boomerang application.
lock_bool is a Boolean variable that may be either true or false. True locks the system and false unlocks the system.

function boomerang_ddx_command(cmd_str, name_str, value_str)
This is the function that is used to issue commands back to the Boomerang application.

Command String Format: command|name|value`
The command string is a concatenation of the above 3 values which are separated by the pipe character “|”. The first element of the command string (referred to as “command” in the command string format specifier above) is a command identifier which instructs the Boomerang application on how to handle the name and value pair which follows as the next two elements. All command strings must end with the back-tic character “`”.

Detailed Process:
1. Obtain the element pointer to the html div tag which is identified by the id-string “boomerang_ddx_content”.

2. Create the command string to be concatenated to the current values which are stored in the <div> identified by the value “boomerang_ddx_content”.

3. Escape the command string so there are no conflicting values.

a. Replace the pipe characters “|” by the literal string “[pipe]”

b. Replace the back-tic characters “`” by the literal string “[backtic]”

4. Lock the Boomerang <ddx> system via the function boomerang_ddx_lock( )
5. Concatenate the full command string to the innerText of the boomerang_ddx_content html div.

6. Unlock the Boomerang <ddx> system via the function boomerang_ddx_lock( )

function boomerang_tracking_url(URL_str, campaign_code)
Returns the URL used to report usage back to the Boomerang server. This allows the Boomerang serve to track URLs accessed by an operator through the Boomerang service.

function boomerang_execute_when (condition_function, execute_function, how_many_attempts)
This is a utility function used to keep code execution concurrent based upon a set condition. For instance, the Boomerang has the ability to load JavaScript libraries from remote servers (i.e. the Boomerang menu system). This function allows the execution of a block of code only after a condition is satisfied and in this example that condition would be the loading status of the requested library JavaScript being set to completely loaded.

function boomerang_call_js (id_str, src_url)
This is a utility function used to include and execute a remote JavaScript file programmatically.

function boomerang_attach_css (id_str, src_url)
This is a utility function which is used to attach a remote cascading style sheet dynamically and programmatically.

function boomerang_openwin (the URL, w, h)
A utility to open up a simple chromeless popup window. A chromeless popup window is a web-browser window that has no status bar, navigator bar, scroll bars, etc.

function boomerang_get_datestring( )
Gets a string used to uniquely identify the current date. Format: YYYY-MM-DD function boomerang_refresh( )
Reloads the current web-page.

function ewmedia_banner_rotator( )
Initiates the advertisement banner rotation system.

function ewmedia_set_rotator_timer( )
Used to set the JavaScript timer for the ad banner rotation system.

function boomerang_submit_user_data( )
Used to report back to the Boomerang server once per day only. This function reports back the GUID and affiliate_username.

function boomerang_cost_per_action( )
Used to detect cost-per-action sales and report sales events back to the Boomerang server. The data collected by this report is used to compute commissions which are paid out to the affiliate who distributed the particular Boomerang to the end-user.

function boomerang_upgrade_notice( )
Displays a notice to the end user that their Boomerang is out of date and provides them with instructions on how to download and install the most recent version of the Boomerang.

function boomerang_is_searchsuggest_triggered( )
Checks the current web-browser URL to see if it is contained in the boomer_searchsuggest_triggers variable and if it is then this function returns true, otherwise the function returns false.

function boomerang_daily_trigger( )
Returns “true” once per day, otherwise it returns “false”.

function boomerang_add_net_hash(net_hash_str)
net hashes are the keys to website notifications. They are unique identifiers which are used to automatically authenticate a user to a website which is affiliated with the Boomerang in some way (e.g., StayRelated.com).
net-hashes are comma separated (no commas on the front or back)
they are contained in boomerang_ddx.net_hashes

function boomerang_do_notifications( )
Checks with the Boomerang server to see if news is available from affiliated web-sites (e.g., StayRelated.com). If news is available this system discretely displays the news to the end user. As an example the Boomerang checks with StayRelated.com to see if any of the current user's friends or family have birthdays in the near future, and if so it then reports that back to the end user.

function boomerang_draw_boomerang(skin, lang)
Loads and displays in the web-browser the specified skin and language combination.

Detailed Process:

1. Run the function boomerang_skin_cleanup( ) if it exists. This function is specified in the separate skin files.

2. Save the current language and skin status into the <ddx> system which reports back to the Boomerang application to be stored.

3. Load the Boomerang dynamic cascading menu system based upon the specified language.

Use the function boomerang_call_js( ) to load and execute the specified skin file.

a. Set all links in the skin which point to eWorld sites to include the affiliates username as the 3rd level part of the domain name.

b. Run the function boomerang_skin_init( ) if it exists. This function is specified in the separate skin files.

c. If the Boomerang search suggest system is loaded make sure it is positioned at the correct height.

d. When the skin file is loaded instruct the web-browser to render it to the current web-page.

Boomerang Launch Script Instantiation Process:

Detailed Process:

1. Check for and report cost-per-action indicators (i.e. if something was purchased on a web-site that is affiliated with the Boomerang).

2. Submit usage data back to the Boomerang server once per day only (just GUID and affiliate_username).

3. Make sure specified eWorld sites have the affiliate_username as the 3rd level domain if they are the current site being visited.

4. Check for live pay-per view event payment page, and if they have already paid then forward them to the streaming video page.

5. Check if the Boomerang should be hidden. Halt execution if the Boomerang should be hidden.

6. Load the Boomerang dynamic cascading menu system.

7. Use the function boomerang_draw_boomerang( ) to instruct the web-browser to display the Boomerang graphics and html from the specified language and skin file.

8. Check if search suggest is triggered, and if so then call the search suggest JavaScript from the Boomerang server.

Data Exchange Communication System:

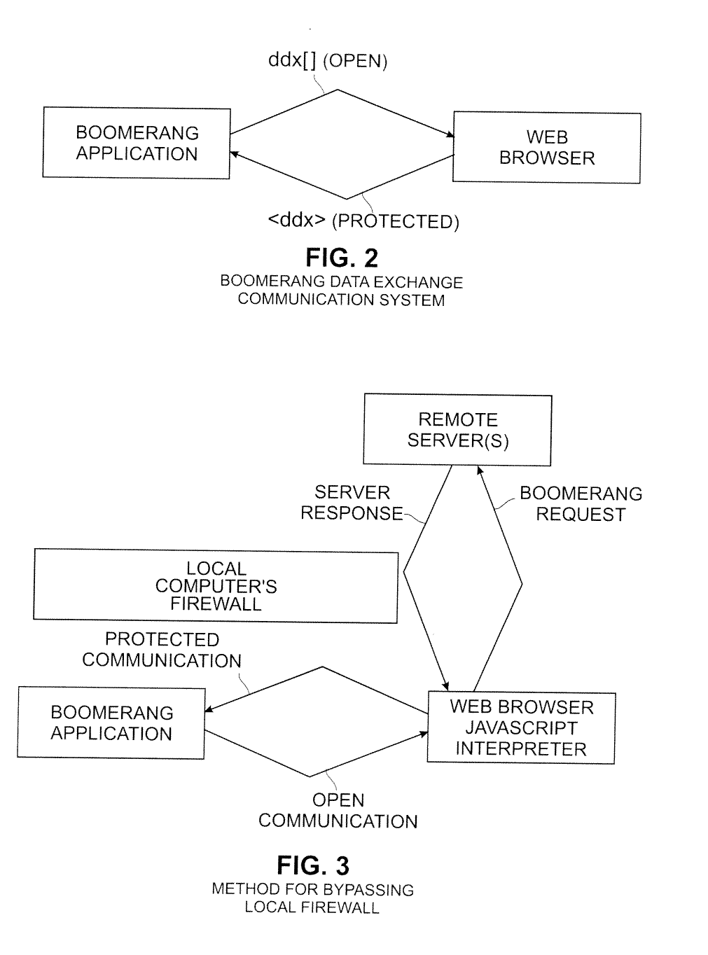

The data exchange communication system is a protocol system that is designed to facilitate communication between the Boomerang application and the “Boomerang launch script” which is run by the web browser's JavaScript interpreter. FIGS. 2 and 3 show schematically the communication channels used for the data exchange communication system. FIG. 2 shows the normal and encrypted communication channels for one instance of the data exchange communication system. FIG. 3 shows the normal and encrypted communication channels when there is the further complication of a firewall on the local computer system.

### DEFINITIONS

GUID: Globally Unique Identifier. This is a value so large that the likelihood of two Boomerangs containing the same value is incredibly small. GUIDs are a commonly occurring tool used to uniquely identify data-sets.

HTTP_LAUNCH_SCRIPT: The script (or URL of the script) that establishes the Boomerang's JavaScript in the current web-browser's web-page. This instance is for non-encrypted communication.

HTTPS_LAUNCH_SCRIPT: The script (or URL of the script) that establishes the Boomerang's JavaScript in the current web-browser's web-page. This instance is for encrypted HTTPS (SSL) communication.

HTTP(S)_LAUNCH_SCRIPT: This represents the HTTP_LAUNCH_SCRIPT or the HTTPS_LAUNCH_SCRIPT depending on the current encryption status of current web-page.

<ddx>: Boomerang Data Exchange Communication System. This symbol represents the “packet drop” communication system responsible for communicating from the web-browser's JavaScript (established by the HTTP(S)_LAUNCH_SCRIPT) to the Boomerang.
this system consists of two hidden HTML tags <div id=“boomerang_ddx_content”> encrypted command string</div> and <div id=“boomerag_ddx_lock”> true or false to prevent synchronization issues</div>.

Note this is a “packet-drop” system. Boomerang ddx commands are put into the inner HTML of this HTML tag and are polled by the Boomerang application.

ddx[ ]: This is the JavaScript associative array which contains the values that are communicated from the Boomerang application. This is also referred to as variable boomerang_ddx or associative array boomerang_ddx[ ] in this document.

Solution for Preventing Remote Usurpation of Boomerang Javascript System:

Necessity for solution: Because the Boomerang's launch script runs in the same thread as the web-browser's JavaScript it is necessary to prevent the possibility of remote web-pages (which could potentially be aware of the Boomerang's JavaScript system) from communicating to the Boomerang application and saving settings to the Boomerang application via the <ddx> packet-drop system.

When the Boomerang application instantiates the Boomerang system in the web-browser by running the Boomerang HTTP(S)_LAUNCH_SCRIPT it passes via the query string three random variable length symmetrical encryption keys, two “id” strings, and the version of the current Boomerang application. These six values are concatenated together via the pipe character into a single string. The resulting concatenated string is then encrypted via an RSA asymmetrical public key (i.e., public/private key system). The remote Boomerang server securely holds the RSA asymmetrical private key.

The six values passed to the HTTP(S)_LAUNCH_SCRIPT:

(Note: key 1, key 2, key 3, id string 1, and id string 2 all change upon every execution of the Boomerang application).
key 1: Symmetrical encryption value for the <ddx> system.
key 2: Symmetrical encryption key for the HTTP(S)_LAUNCH_SCRIPT's variable names and values.
key 3: Symmetrical encryption key for the HTTP(S)_LAUNCH_SCRIPT's function names.
id string 1: This is the alternate value for the id of the HTML element which contains the encrypted command string for the <ddx> system.
id string 2: This is the alternate value for the id of the HTML element which contains the lock status of the <ddx> system.
version: This is the version of the current Boomerang application.

ASYMMETRICAL CYPHER=RSA(key 1|key 2|key 3|id string 1|id string 2| version)

The Boomerang application contains the RSA asymmetrical public encryption key which is used to encrypt the above asymmetrical cypher.

The remote HTTP(S)_LAUNCH_SCRIPT is generated via a remote server-side CGI application (e.g. PHP) which is referenced by the web-browser as if it were a JavaScript file.

This remote server-side CGI application contains the RSA asymmetrical private key which is used to decrypt the asymmetrical cypher that is passed to the application via the query string.

The remote server-side CGI application, when executing, dynamically replaces all variable name-value pairs with cyphers generated via “key 2”.

The remote server-side CGI application when executing dynamically replaces all function names with cyphers generated via “key 3”.

The HTTP(S)_LAUNCH_SCRIPT then uses “key 1” to securely communicate back to the Boomerang application via the <ddx> packet drop system.

### Example

<div id=“id string 1” style=“display:none;”> encrypted command string</div>

<div id=“id string 2” style=“display:none;”> true or false to prevent synchronization issues</div>

Notice: The modified function names and variable name-value pairs make it extremely unlikely that a remote web-page could bypass this security system and communicate to the Boomerang application. Also note that the symmetrical keys “key 1, key 2, and key 3” are variable length and change every time the Boomerang application is executed. In addition to this security measure the symmetrical keys are held private because of the RSA asymmetrical encryption that is used when submitting them to the remote server-side CGI application which generates the HTTP(S)_LAUNCH_SCRIPT.

The invention is susceptible to various modifications and alternative forms, and specific examples thereof have been shown by way of example in the specification and drawings. It should be understood, however, that the invention is not to be limited to the particular forms or methods disclosed, but to the contrary, the invention is to cover all modifications, equivalents, and alternatives.

What is claimed is:

1. A method for exchanging data with a server comprising:
providing a launch script stored on a server;
providing on an end-user computer an executable application capable of obtaining the launch script from the server:
injecting and executing the launch script on each of a plurality of web browsers running on the end-user computer such that the executable application can access a rich-media function through which an operator of the end-user computer can obtain data and perform on-line activities;
communicating the operator's on-line activities to the remote server; and
providing, through the executable application, a plurality of suggestions to the operator based on the operator's on-line activities.

2. The method as set forth in claim 1 wherein the launch script includes a library of utilities.

3. The method as set forth in claim 1 wherein the rich media includes a dynamic cascading menu system through which the operator can select and access one or more websites.

4. A data exchange communication system comprising:
a server having a memory that stores a launch script and an end-user computer connected to the server via a network, the end-user computer comprising an executable application capable of obtaining the launch script from the server and injecting and executing the launch script on each of a plurality of web browsers running on the end-user computer such that the executable application renders a rich-media through which an operator of the end-user computer can obtain data and perform on-line activities, and wherein the executable application communicates the operator's on-line activities to the server and provides a plurality of suggestions to the operator based on the operator's on-line activities.
